(19) United States
(12) Patent Application Publication
(10) Pub. No.: US 2023/0271274 A1
(43) Pub. Date: Aug. 31, 2023

(54) LASER ENGRAVING MACHINE HAVING DUAL QUICK RELEASE MIRROR HOLDERS

(71) Applicant: GREAT COMPUTER CORP., New Taipei City (TW)

(72) Inventors: Liang SHIH, New Taipei City (TW); Tien-Chuan HUANG, New Taipei City (TW)

(21) Appl. No.: 17/680,957

(22) Filed: Feb. 25, 2022

(51) Int. Cl. B23K 26/364; B23K 26/082

(52) U.S. Cl. CPC B23K 26/364; B23K 26/082

(57) ABSTRACT

A laser engraving machine having dual quick release mirror holders is provided. The laser engraving machine comprises a machine station, a first mirror holder and a second mirror holder. The machine station has a working platform, a rail and a first laser tube. The first mirror holder is disposed on the rail and receives the laser light emitted from the first laser tube for carrying out a laser processing on the working platform when moves back and forth on the rail. The second mirror holder is composed of a second laser tube assembled on an output module, wherein the output module has a first binding portion and a second binding portion. The first binding portion detachably attaches to the rail for the second mirror holder to move on the rail. The second binding portion detachably attaches to the first mirror holder.

### BACKGROUND OF THE INVENTION

### Field of the Invention

The present invention relates to a simple structure and low-cost laser engraving machine. The laser engraving machine has dual quick release mirror holders and laser light outputs with different wattages.

### Description of the Related Art

The basic principle of a general laser processing machine is to guide and focus the light beam output by the laser to the surface of the object to be engraved. After the focused beam is absorbed by the object, the temperature of the material of the object rises suddenly and the material vaporizes, making the surface of the object be concaved to achieve the purpose of engraving and cutting.

For the conventional laser cutting machine, before cutting, the workpiece must be placed at a fixed position, and then the laser light is emitted from the laser tube to enter the X/Y platform laser output module or the three-axis vibrating lens laser output module to achieve the required cutting actions through the computer control stroke. So the current machine design is divided into an X/Y platform laser output module and a three-axis vibrating lens laser output module for consumers to choose and buy.

However, no matter which of the aforementioned modules of the machine, the configuration of the laser tube is set in the machine, and then the laser light is guided to the output module on the working platform through the arrangement of the light path. If laser output of different wavelengths is required, the machine must be built with two laser tubes, and it needs to be designed with two light paths, or uses a switching device to switch the output of laser light of different wavelengths, so that laser output of different wavelengths can be performed on the same machine.

### SUMMARY OF THE INVENTION

However, the above-mentioned machine design, due to the need to accommodate several laser tubes, will inevitably increase the size of the machine, and at the same time need to increase the design and planning of the light path or the demand for switching devices, which not only increases the cost of the machine, but also increases the overall system complexity. Neither the efficiency in use nor the maintenance after use has not been improved too much. Therefore, how to effectively improve is highly appreciated by those skilled in the art and users.

The purpose of the present invention is to provide a simple structure, low-cost laser engraving machine. The laser engraving machine has dual quick release mirror holders and laser light outputs with different wattages.

To achieve the above-mentioned purpose, the present invention provides a laser engraving machine having dual quick release mirror holders, which comprises a machine station, a first mirror holder and a second mirror holder. The machine station has a working platform for a workpiece to be disposed thereon, wherein the machine station is provided with a rail mounted above the working platform, and a first laser tube for emitting a laser light along a light path. The first mirror holder is disposed on the rail and receives the laser light emitted from the first laser tube along the light path for carrying out a laser processing on the workpiece on the working platform when moves back and forth on the rail. The second mirror holder is composed of a second laser tube assembled on an output module, wherein the output module has a first binding portion and a second binding portion. The first binding portion detachably attaches to the rail for the second mirror holder to move on the rail. The second binding portion detachably attaches to the first mirror holder to allow the second mirror holder to separately perform a laser output or synchronously perform the laser output with the first mirror holder.

In an implementation, the laser light wavelengths of the first laser tube and the second laser tube are different.

In an implementation, the first binding portion of the output module is a roller set for engaging the rail and moving thereon.

In an implementation, the second binding portion is a joint connector, and a position of the first mirror holder corresponding to the second binding portion is disposed with a connecting interface, so as to allow the first mirror holder drives the second mirror holder to move on the rail after the joint connector connects with the connecting interface.

The invention will become better understood with regard to the following detailed description of the preferred but non-limiting embodiments. The following description is made with reference to the accompanying drawings and denotations to describe specific content and expected results of the present invention.

### BRIEF DESCRIPTION OF THE DRAWINGS

FIG. 1 shows a diagram of a three-dimensional appearance of a machine in an embodiment of the present invention;

FIG. 2 shows a diagram of the connection structure between the first mirror holder and the first laser tube in an embodiment of the present invention;

FIG. 3 shows a diagram of the first mirror holder engaging the second mirror holder on a rail in an embodiment of the present invention;

FIG. 4 shows a diagram of a state when the first mirror holder is detached from the second mirror holder in an embodiment of the present invention; and

FIG. 5 shows a diagram of the second mirror holder from another aspect in an embodiment of the present invention.

### DETAILED DESCRIPTION OF THE INVENTION

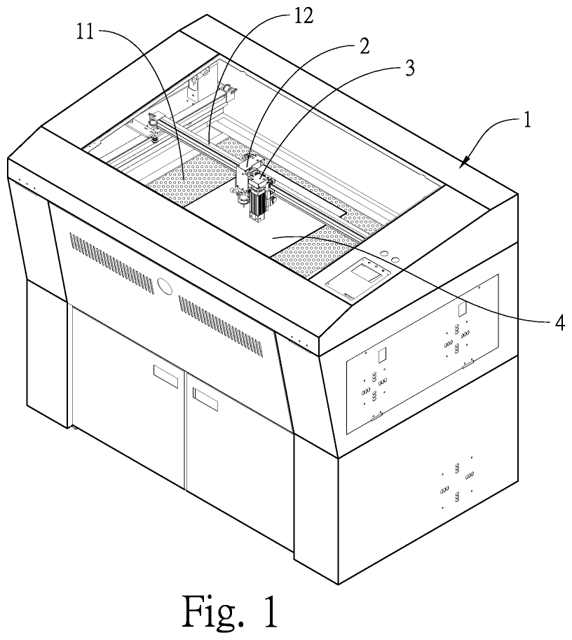

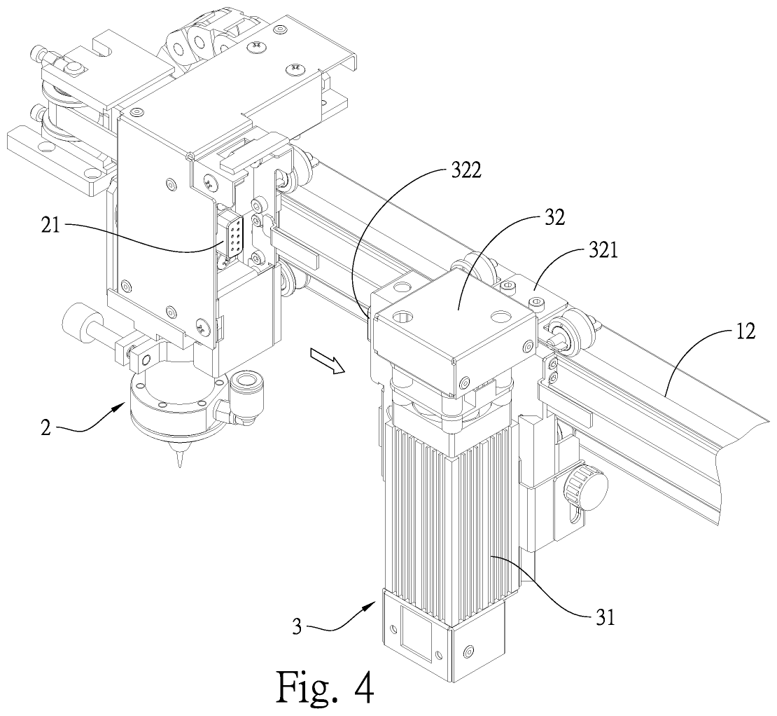

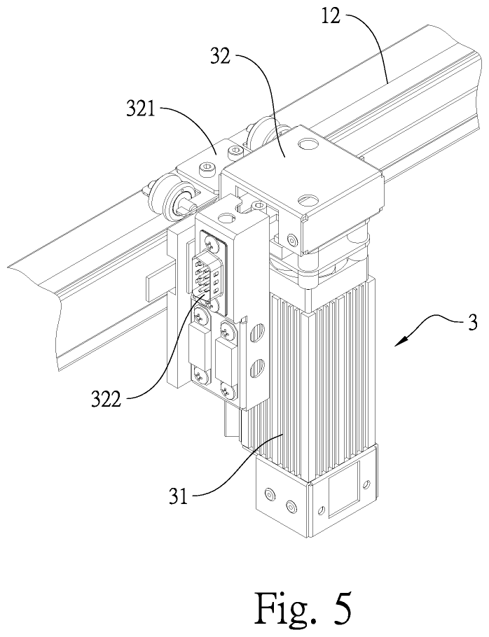

Please refer to FIG. 1 to FIG. 5, which show an embodiment of a laser engraving machine having dual quick release mirror holders. The laser engraving machine is composed of a machine station 1, a first mirror holder 2 and a second mirror holder 3 configured on the machine station 1.

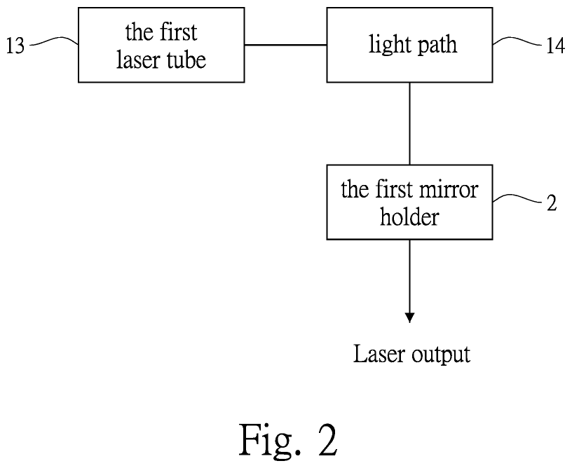

As shown in FIGS. 1 and 2, a machine station 1 has a working platform 11 for a workpiece 4 disposed thereon, and the working platform 11 is mounted a rail 12 thereon. The machine station 1 is futher configured to dispose a first laser tube 13.

The first mirror holder 2 is disposed on the rail 12, wherein the first mirror holder 12 receives the laser light from the first laser tube 13 via a light path 14 (as shown in FIG. 2) so that when the first mirror holder 2 moves on the rail 12 back and forth, the workpiece 4 is performed by a laser processing on the working platform 11.

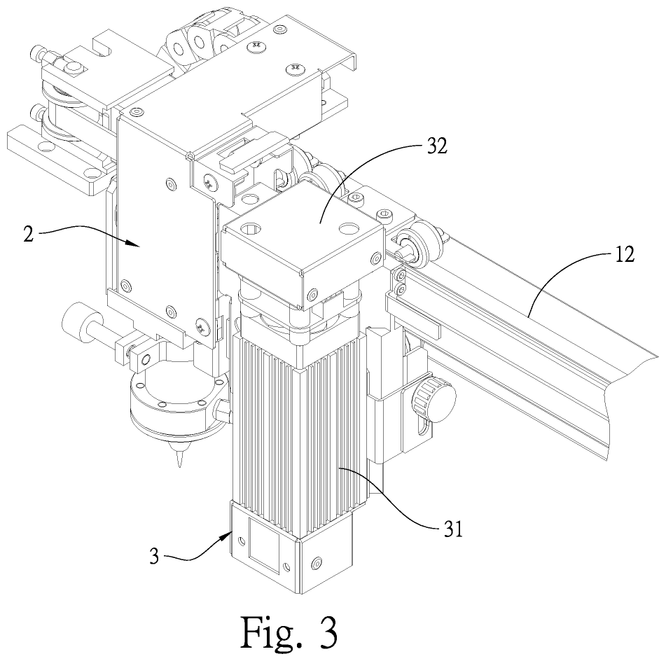

As shown in FIGS. 3 to 5, the second mirror holder 3 is composed of a second laser tube 31 assembled on an output module 32. The laser wavelengths of the first laser tube 13 and the second laser tube 31 are different, and the wattage of the second laser tube 31 is lower than that of the first laser tube 13. The output module 32 has a first binding portion 321 and a second binding portion 322. The first binding portion 321 of the output module 32 is a roller set for engaging the rail 12 detachably. After the first binding portion 321 engages the rail, the second mirror holder 3 can move on the rail 12. The second binding portion 322 is a joint connector which can engage the first mirror holder 2 detachably. A position of the first mirror holder 2 is configured to dispose a connecting interface 21 corresponding to the second binding portion 322, so as to allow the first mirror holder 2 drives the second mirror holder 3 to move on the rail after the joint connector (the second binding portion 322) connects with the connecting interface. The second mirror holder 3 and the first mirror holder 2 perform a laser output on the working platform 11 separately or synchronously (as shown in FIG. 1).

Therefore, when implemented, the second mirror holder 3 can move on the rail 12 via the first binding portion 321 (i.e. roller set), and the second binding portion 322 is engaged with the connecting interface 21 of the first mirror holder 2. Therefore, when the laser processing operation is performed, the first mirror holder 2 is driven to move, and then the second mirror holder 3 can be moved synchronously, so as to respectively perform engraving or cutting operations with different laser wavelength outputs.

Thereby, there are following advantages in the present invention:

1. With the design of the second mirror holder of the present invention and the second laser tube loaded on it, it can be connected with the first mirror holder in a detachable design. The design of the duel mirror holder can perform the output of different laser wavelengths separately or synchronously. There is no need to change the existing structure design of the machine to install other laser tubes or change the light paths. Two laser outputs can be performed on the rail without switching, which greatly improves work efficiency.

2. The second mirror holder of the present invention can be connected with the first mirror holder through a simple connecting design (such as snap connection, magnetic attraction or locking, etc.). It does not need to spend too much time for the operator in the follow-up installation or maintenance, which is very convenient.

3. Since the present invention utilizes the design of attaching a second mirror holder, the second laser tube on the second mirror holder can be replaced according to different processing requirements to achieve the laser light output of different wattages.

An embodiment of the present invention and the technical means applied are as described above. Based on the disclosure or teaching of the description, numerous variations and modifications may be derived, which are to be considered as equivalent changes of the concept of the present invention. Hence, the effectiveness generated by such variations and modifications are within the substantial spirits covered by the description and drawings, and are to be encompassed within the technical scope of the present invention.

In conclusion, based on the above disclosure, the laser engraving machine having dual quick release mirror holders of the present invention is capable of achieving expected objects of the present invention, and provides industrial applicability. Therefore, a patent application is submitted accordingly.

It should be understood that different modifications and variations could be made from the disclosures of the present invention by the people familiar in the art, which should be deemed without departing the spirit of the present invention.

What is claimed is:

1. A laser engraving machine having dual quick release mirror holders, comprising:
a machine station having a working platform for a workpiece to be disposed thereon, wherein the machine station is provided with a rail mounted above the working platform, and a first laser tube for emitting a laser light along a light path;
a first mirror holder disposed on the rail and receiving the laser light emitted from the first laser tube along the light path for carrying out a laser processing on the workpiece on the working platform when moves back and forth on the rail;
a second mirror holder composed of a second laser tube assembled on an output module, wherein the output module have a first binding portion and a second binding portion, and the first binding portion detachably attaches to the rail for the second mirror holder to move on the rail, and the second binding portion detachably attaches to the first mirror holder to allow the second mirror holder to separately perform a laser output or synchronously perform the laser output with the first mirror holder.

2. The laser engraving machine according to claim 1, wherein a laser wavelength of the laser light of the second mirror holder is different from that of the first mirror holder.

3. The laser engraving machine according to claim 1, wherein the first binding portion of the output module is a roller set for engaging the rail and moving thereon.

4. The laser engraving machine according to claim 1, wherein the second binding portion is a joint connector, and a position of the first mirror holder corresponding to the second binding portion is disposed with a connecting interface, so as to allow the first mirror holder drives the second mirror holder to move on the rail after the joint connector connects with the connecting interface.
